(19) United States
(12) Patent Application Publication
(10) Pub. No.: US 2014/0105643 A1
(43) Pub. Date: Apr. 17, 2014

(54) IMAGE FORMING APPARATUS HAVING A BRUSH MEMBER

(71) Applicant: CANON KABUSHIKI KAISHA, Tokyo (JP)

(72) Inventors: Seiji Saito, Mishima-shi (JP); Takuma Abe, Mishima-shi (JP); Masaru Shimura, Numazu-shi (JP); Ken Nakagawa, Mishima-shi (JP); Kenji Kanari, Numazu-shi (JP); Takamitsu Soda, Mishima-shi (JP); Takaaki Akamatsu, Suntou-gun (JP); Kazuhiro Doda, Yokohama-shi (JP); Takashi Shimada, Moriguchi-shi (JP); Shuuichi Tetsuno, Numazu-shi (JP)

(21) Appl. No.: 14/051,618

(22) Filed: Oct. 11, 2013

Related U.S. Application Data
(62) Division of application No. 12/391,577, filed on Feb. 24, 2009, now abandoned.

(30) Foreign Application Priority Data
Feb. 28, 2008 (JP) 2008-048839

(51) Int. Cl. G03G 15/24

(52) U.S. Cl. CPC G03G 15/24
USPC 399/148

(57) ABSTRACT

An image forming apparatus includes an image bearing member for carrying a toner image, a movable intermediary transfer member for receiving the toner image from the image bearing member, a primary transfer member for primary transfer of the toner image from the image bearing member onto the intermediary transfer member, a secondary transfer member for being supplied with a voltage and for secondary transfer of the toner image from the intermediary transfer member onto a transfer material, and a first toner charging member. A first charging member rubs a surface of the intermediary transfer member with movement thereof, and a second charging member moves in contact with the intermediary transfer member, thereby transferring toner remaining on the intermediary transfer member after the secondary transfer back to the image bearing member from the intermediary transfer member simultaneously with the primary transfer at the primary transfer station.

### FIELD OF THE INVENTION AND RELATED ART

The present invention relates to an image forming apparatus which employs an electrophotographic or electrostatic image forming system. More specifically, it relates to those which employ an intermediary transfer system, that is, a transfer system which first transfers a toner image formed on an image bearing member, onto an intermediary transfer member, and then, transfers the toner image from the intermediary transfer member onto a final transfer medium.

There have been known various image forming apparatuses, for example, copying machines, printers, etc., which employ an electrophotographic image forming system and an intermediary transfer system. An intermediary transfer system is such a transfer system that uses an intermediary transfer member to transfer an image from an image bearing member onto a final image bearing medium. That is, an image forming apparatus which employs an intermediary transfer system can form a color image (multilayer image) on a transfer medium through a primary transfer process and a secondary transfer process.

More specifically, in the first transfer process, a toner image (transferable image) formed on the surface of an electrophotographic photosensitive member (photosensitive member as image bearing member) is transferred onto an intermediary transfer medium. This primary transfer process is repeated to place multiple monochromatic images (different in color) on the surface of the intermediary transfer medium. In the second transfer process, the multiple monochromatic toner images are transferred all at once onto the surface of a transfer medium, for example, a sheet of paper. After the transfer of the toner images onto the recording medium, the toner images are fixed to the transfer medium by a fixing means. This is how a full-color image is formed.

However, a certain (small) amount of toner in a toner image formed on an image bearing member fails to be transferred from an intermediary transfer medium onto the final transfer medium in the secondary transfer process, remaining therefore on the intermediary transfer medium (this portion of toner will be referred to as transfer residual toner). The transfer residual toner has to be removed from the intermediary transfer medium. Japanese Laid-open Patent Application H09-50167 proposes a method for removing the transfer residual toner from an intermediary transfer medium. This method is one of the so-called simultaneous cleaning methods. In the case of this method, the transfer residual toner on the intermediary transfer medium is charged by a charging means to the polarity opposite to the polarity to which toner is normally charged, and then, the transfer residual toner is transferred back onto (recovered) the photosensitive member during the following primary transfer process. The polarity to which toner is normally charged is the toner polarity prior to the transfer of the toner image from the intermediary transfer medium onto the final transfer medium.

To describe more concretely this so-called simultaneous cleaning method, referring to FIG. 4 in this application of the present invention, in the case of the image forming apparatus disclosed in Japanese Laid-open Patent Application H09-50167, multiple toner images are formed on a photosensitive member 201 (image bearing member) with the use of developing apparatuses 4a-4d, and then, are transferred (primary transfer) onto the intermediary transfer medium 206 in the primary transfer portion N1. Then, the toner images are transferred (secondary transfer) from the intermediary transfer medium 206 onto a final transfer medium P in the secondary transfer portion N2. However, a small amount of the toner of the toner image on the intermediary transfer belt fails to be transferred onto the recording medium, remaining on the intermediary transfer medium 206 after the secondary transfer of the toner images. Hereafter, the toner remaining on the intermediary transfer medium after the secondary transfer will be referred to as transfer residual toner. To the transfer residual toner, a bias which is opposite in polarity to the normal polarity to which the photosensitive drum is charged by a charging means 212, is charged. Thus, the transfer residual toner becomes positively charged. Then, the positively charged transfer residual toner is moved by the further rotation of the intermediary transfer medium 206 through the primary transfer portion N1. While the transfer residual toner is being conveyed through the primary transfer portion N1, a bias, which is opposite (positive in drawing) in polarity to the polarity to which the toner is normally charged, is charged to the intermediary transfer medium 206 to transfer the toner (toner image) on the photosensitive drum 206 onto the intermediary transfer medium 206. As a result, the transfer residual toner is transferred back onto the photosensitive drum 201. After being transferred back onto the photosensitive drum 201, the transfer residual toner is recovered by a cleaner 207, which is the cleaning means for cleaning the peripheral surface of the photosensitive drum 201. The cleaner 207 has a cleaning member, such as a cleaning blade, which is placed in contact with the peripheral surface of the photosensitive drum 201 to scrape away the transfer residual toner. This structural arrangement makes it possible to remove the transfer residual on the intermediary transfer medium, which has resulted from the formation of the toner image for the immediately preceding page (transfer medium), at the same time as the toner image for the following page (transfer medium) is transferred. In other words, this structural arrangement makes it possible to continuously form images without being slowed in printing speed for the removal of the transfer residual toner.

Further, a structural arrangement for improving an image forming apparatus in terms of the efficiency with which the transfer residual toner on the intermediary is charged is proposed in Japanese Laid-open Patent Application H10-49023. More concretely, this image forming apparatus applies a combination of AC and DC voltages as a charge bias to its charging means for charging the transfer residual toner on the intermediary transfer member. That is, it employs such a cleaning method that uses DC voltage to charge the transfer residual toner while using the AC voltage to scatter the transfer residual toner.

However, the image forming apparatus disclosed in Japanese Laid-open Patent Application H10-49023 suffers from a problem resulting from the abovementioned application of the combination of AC and DC voltages. That is, since the apparatus places the transfer residual toner, which is unstable in its charge, in an alternating electric field, the transfer residual toner is excessively scattered by the alternating electric field. It is possible to use a lower alternating voltage to prevent the transfer residual toner from being excessively scattered. However, the usage of a lower alternating voltage makes it difficult to desirably scatter the transfer residual toner.

There is another problem. That is, as an image forming apparatus is repeatedly used for image formation, the toner in the apparatus deteriorates. As the toner in the apparatus deteriorates, it becomes unevenly distributed in the developing apparatus. Thus, as the abovementioned alternating field is reduced in magnitude to prevent the toner from being excessively scattered, the alternating field fails to evenly scatter the transfer residual toner. As a result, the transfer residual toner becomes unevenly charged. In the case of an image forming apparatus in which the transfer residual toner is removed from the photosensitive drum 201 at the same time as the photosensitive drum 201 is charged, the transfer residual toner is transferred back onto the photosensitive drum 201 after it is charged by the charging member. Thus, if the transfer residual toner is nonuniform in charge, it is unevenly transferred back onto the photosensitive drum 201. That is, reducing the combination of AC and DC voltages to be applied to the intermediary transfer member to charge the transfer residual toner on the intermediary transfer member makes it impossible to satisfactorily remove the transfer residual toner from the intermediary transfer belt at the same time as an image is transferred from the photosensitive drum 201 onto the intermediary transfer member. This sometimes results in the formation of unsatisfactory images.

As described above, in a case where the simultaneous cleaning method, that is, the method which transfers the transfer residual toner on an intermediary transfer belt, back onto the image bearing member at the same time as a toner image is transferred from the image bearing member onto the intermediary transfer belt, is employed, it is a serious subject how to uniformly charge the transfer residual toner on the intermediary transfer member while uniformly scattering the transfer residual toner.

### SUMMARY OF THE INVENTION

Thus, the primary object of the present invention is to provide an image forming apparatus which employs a method for cleaning its intermediary transfer medium at the same time as it transfers a toner image onto the intermediary transfer medium, and yet, is capable of more evenly scattering the transfer residual toner on the intermediary transfer member and more uniformly charging the transfer residual toner, without applying an AC voltage to its charging member, than any of image forming apparatuses in accordance with the prior arts.

According to an aspect of the present invention, there is provided an image forming apparatus, comprising an image bearing member for carrying a toner image; a movable intermediary transfer member for receiving the toner image from said image bearing member; a primary transfer member for being supplied with a voltage and for primary transfer of the toner image from said image bearing member onto said intermediary transfer member in a primary tranfser station; a secondary transfer member for being supplied with a voltage and for secondary transfer of the toner image from said intermediary transfer member onto a transfer material in a secondary transfer station; a first charging member for electrically charging toner remaining in a region upstream of the primary transfer station and downstream of the secondary transfer station; a first voltage source for applying a voltage to said first charging member; and a second charging member for electrically charging the toner remaining in a region upstream of the primary transfer station and downstream of said first charging member; a second voltage source for applying a voltage to said second charging member, wherein said first charging member rubs a surface of said intermediary transfer member with movement of said intermediary transfer member, and said second charging member moves in contact with said intermediary transfer member in the same direction as said intermediary transfer member in a contact region therebetween, thereby to transfer the toner remaining on said intermediary transfer member after the secondary transfer, back to said image bearing member from said intermediary transfer member simultaneously with the primary transfer at the primary transfer station.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a schematic sectional view of the image forming apparatus in the first preferred embodiment of the present invention.

FIG. 2 is an enlarged schematic sectional view of the cleaning brush and cleaning roller of the image forming apparatus shown in FIG. 1, and their adjacencies.

FIG. 3 is a schematic drawing of a cleaning brush which reciprocally moves.

FIG. 4 is a schematic sectional view of an example of an image forming apparatus in accordance with the prior arts.

### DETAILED DESCRIPTION OF THE PREFERRED EMBODIMENTS

Hereinafter, the present invention will be described with reference to the preferred embodiments of the present invention, and the appended drawings. However, the measurements, materials, and shapes of the structural components of the image forming apparatuses, and their positional relationship, which are disclosed in the following description of the preferred embodiments of the present invention, are to be modified or adjusted in accordance with the structure, features, etc., of an apparatus to which the present invention is applied, and the conditions under which the apparatus is used. In other words, the following preferred embodiments of the present invention are not intended to limit the present invention in scope, unless specifically noted.

### Embodiment 1

### 1. General Structure of Image Forming Apparatus

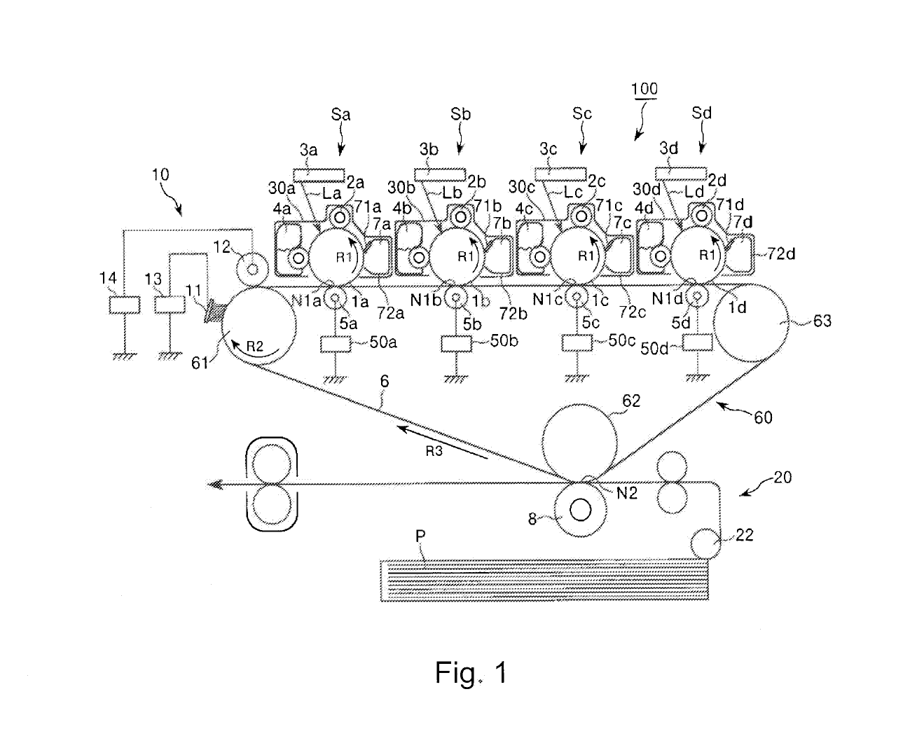

FIG. 1 is a schematic sectional view of the image forming apparatus in the first preferred embodiment of the present invention. An image forming apparatus 100 in this embodiment is an electrophotographic full-color laser beam printer. The image forming apparatus 100 is of the so-called tandem type, and uses an intermediary transfer system. That is, the image forming apparatus 100 records an image on recording medium using the following method: It sequentially forms multiple monochromatic color toner images (images formed of toner) on its image bearing member or members, based on image formation data obtained by separating an intended image into multiple monochromatic color components. Then, it transfers (primary transfer) in layers the multiple monochromatic color toner images onto its intermediary transfer member. Finally, it transfers all at once (secondary transfer) the layered multiple monochromatic images onto the transfer medium to obtain a recorded image of the original.

The image forming apparatus 100 has multiple image formation stations, more specifically, the first, second, third, and fourth image formation stations Sa, Sb, Sc, and Sd, which are for forming yellow (Y), magenta (M), cyan (C), and black (K) toner images, respectively.

The stations Sa-Sd in this embodiment are roughly the same in structure and operation. Hereafter, therefore, unless they need to be differentiated, they will be described together without using the suffixes a, b, c, and d of the referential code, which are used in the drawings to indicate the color of the monochromatic images.

Each station S of the image forming apparatus 100 has a photosensitive drum 1, which is an electrophotographic photosensitive member 1 in the form of a drum. The photosensitive drum 1 is rotationally driven by a driving means (unshown) in the direction (counterclockwise direction) indicated by an arrow mark R1. The peripheral surface of the photosensitive drum 1 is uniformly charged by a charge roller 2 (primary charging device) as a charging means, across the portion which has come into contact with the charge roller 2. Then, a beam of laser light L is projected, while being modulated with the image formation data, from an exposing apparatus 3 onto the uniformly charged portion of the peripheral surface of the photosensitive drum 1. As a result, an electrostatic latent image (electrostatic image) is formed on the uniformly charged portion of the peripheral surface of the photosensitive drum 1. As the uniformly charged portion of the peripheral surface of the photosensitive drum 1 is advanced further in the direction R1, the latent image formed on the peripheral surface 1 in accordance with the image formation data is developed by a developing apparatus 4, as a developing means, into a visible image, that is, an image formed of toner (which hereafter will be referred to as toner image). The developing apparatus 4, that is, the developing means in this embodiment, develops the latent image on the photosensitive drum 1 with the use of the so-called reversal developing method. That is, the developing apparatus 4 develops the latent image by adhering toner, which is the same in polarity as that (which is negative in this embodiment) of the peripheral surface of the photosensitive drum 1, to the points of the charged portion of the peripheral surface of the photosensitive drum 1, which has been reduced in potential level by the exposure.

In terms of the moving direction of the peripheral surface of the photosensitive drum 1, which is indicated by the arrow mark R1 in the drawing, an intermediary transfer belt 6, which is an image transferring intermediary member, is on the downstream side of the developing position.

The intermediary transfer belt 6 is a cylindrical and endless piece of film, which is stretched around three rollers 61, 62, and 63. The intermediary transfer belt 6 is suspended by the rollers 61 and 63, which are a driver roller and tension roller, respectively. The roller 62 is the roller which opposes a secondary transfer roller 8. As the drive roller 61 is rotationally driven in the direction indicated by an arrow mark R2 in the drawing (clockwise direction), the intermediary transfer belt 6 circularly moves (rotates) in the direction indicated by an arrow mark R3 in the drawing, at roughly the same speed as the speed at which the peripheral surface of the photosensitive drum 1 moves (peripheral speed).

There are primary transfer rollers 5 as the image transferring first means. They are disposed in a manner to oppose the photosensitive drums 1, one for one, with the intermediary transfer belt 6 sandwiched between the primary transfer rollers 5 and photosensitive drums 1. Each primary transfer roller 5 keeps the intermediary transfer belt 6 pressed on the corresponding photosensitive drum 1, forming thereby the primary transfer portion N1 (primary transfer nip), in which the photosensitive drum 1 and intermediary transfer belt 6 contact with each other.

The intermediary transfer belt 6 stretched around the drive roller 61, belt backing roller 62, and tension roller 63, primary transfer rollers 5a-5d, etc., make up an intermediary transfer unit 60.

As the photosensitive drums 1 and intermediary transfer belt 6 are rotated, the toner images formed on the photosensitive drums 1, one for one, are transferred (first transfer) onto the outward surface of the intermediary transfer belt 6 by the primary transfer rollers 5. During this process, a primary transfer bias, which is opposite (positive in this embodiment) in polarity to the normal polarity to which toner is charged, is applied to the primary transfer rollers 5 from a primary transfer power source 50, that is, the means for supplying primary transfer voltage. Thus, during the primary transfer process, an electric field, which moves the normally charged toner from the photosensitive drum 1 onto the intermediary transfer belt 6 is formed in each of the primary transfer portion N1.

Also during the primary transfer process, a certain (small) amount of toner on each photosensitive drum 1 fails to transfer onto the intermediary transfer belt 6, and remains on the photosensitive drum 1. The transfer residual toner, or the toner having failed to transfer onto the intermediary transfer belt 6, is removed by a cleaner 7 as a means for cleaning the photosensitive drum 1. The cleaner 7 has a cleaning blade 71, which is a cleaning member formed of a plate of an elastic substance. The cleaner 7 is disposed so that the cleaning blade 71 remains in contact with the peripheral surface of the photosensitive drum 1. The cleaner 7 is also provided with a toner container 72 for storing the toner removed from the peripheral surface of the photosensitive drum 1 by the cleaning blade 71.

The charging, exposing, developing, and primary transfer processes, are sequentially carried out in the first to fourth stations Sa-Sd, starting from the first station Sa, or the most upstream station in terms of the moving direction of the outward surface of the intermediary transfer belt 6. That is, the image forming processes are carried out in the order of yellow, magenta, cyan, and black colors. As a result, multiple monochromatic images, different in color, are placed in layers on the intermediary transfer belt 6. For example, in a case where a full-color image is to be formed, yellow, magenta, cyan, and black monochromatic images are layered on the intermediary transfer belt 6.

There is a secondary transfer roller 8, which is a means for transferring the monochromatic color images for the second time. The secondary transfer roller 8 is disposed so that it opposes the aforementioned belt backing roller 62, with the presence of the intermediary transfer belt 6 between the two rollers 8 and 62. The secondary transfer roller 8 is pressed against the belt backing roller 62 with the presence of the intermediary transfer belt 6 between the two rollers 8 and 62, forming thereby a secondary transfer portion N2 (secondary transfer nip) between the intermediary transfer belt 6 and secondary transfer roller 8.

The toner images on the intermediary transfer belt 6 are transferred (second transfer) onto a sheet of transfer medium P (which hereafter will be referred to simply as transfer medium P) by the secondary transfer roller 8. More specifically, the image forming apparatus 100 is provided with a transfer medium supplying portion 20, in which transfer mediums P are stored. The transfer medium P is fed, with a preset timing, into the main assembly of the image forming apparatus 100 by a feed roller 22 from the transfer medium supplying portion 20, and then, is delivered to the aforementioned secondary transfer portion N2, in which the intermediary transfer belt 6 is in contact with the secondary transfer roller 8. To the secondary transfer roller 8, a secondary transfer bias, which is opposite (positive in this embodiment) to that of the normally charged toner, begins to be applied from a secondary transfer power source (unshown), roughly at the same time as the delivery of the transfer medium P to the secondary transfer portion N2, which is a means for supplying the secondary transfer roller 8 with the secondary transfer voltage. As a result, an electric field, which causes the normally charged toner to transfer from the intermediary transfer belt 6 onto the transfer medium P, is formed in the secondary transfer portion N2 during the secondary transfer process.

The transfer residual toner particles on the intermediary transfer belt 6, that is, the toner particles which were not transferred onto the transfer medium P from the intermediary transfer belt 6 during the secondary transfer process, are first charged to the normal polarity by a cleaning brush 11, that is, a first charging brush, while being uniformly scattered by the brush 11. Then, charge is given to the transfer residual toner particles by a cleaning roller 12 as a second charging member, in order to erase the pattern in which the transfer residual toner particles are distributed on the intermediary transfer belt 6, by evenly dispersing the transfer residual toner particles on the intermediary transfer belt 6 across the intermediary transfer belt 6. That is, in this embodiment, the transfer residual toner particles are evenly scattered across the intermediary transfer belt 6 by sweeping the intermediary transfer belt 6 with the cleaning brush 11 while the transfer residual toner particles on the intermediary transfer belt 6 are moved through the interface between the cleaning brush 11 and intermediary transfer belt 6; AC voltage is not applied to scatter the transfer residual toner particles.

The cleaning brush 11 is in connection with a first cleaning power source 13 (first power source), which is the means for supplying the cleaning brush 11 with cleaning voltage. The cleaning roller 12 is in connection with a second cleaning power source 14 (second power source), which is the means for supplying the cleaning roller 12 with the second cleaning voltage. The cleaning brush 11, cleaning roller 12, first cleaning power source 13, and second cleaning power source 14 make up an intermediary transfer member cleaning means 10. In terms of the moving direction of the outward surface of the intermediary transfer belt 6, both the cleaning brush 11 and cleaning roller 12 are on the down stream side of the secondary transfer portion N2, and on the upstream side of the transfer portion of the first station Sa. In this embodiment, therefore, the cleaning brush 11 and cleaning roller 12 charge the transfer residual toner particles, that is, the toner particles remaining on the intermediary transfer belt 6 after the secondary transfer, on the upstream side of the first transfer portion N1a of the first station Sa. It should be noted here that in terms of the moving direction of the outward surface of the intermediary transfer belt 6, the cleaning brush 11 is on the upstream side of the cleaning roller 12.

Also in this embodiment, after the transfer residual toner particles are given electric charge by the cleaning brush 11 and cleaning roller 12, the transfer residual toner particles are transferred back onto the photosensitive drum 1a in the first station Sa during the following primary transfer process (belt cleaning method which cleans intermediary transfer belt while transferring toner image). After the transfer residual toner particles having adhered to the photosensitive drum 1a by being transferred back from the intermediary transfer belt 6 onto the photosensitive drum 1a are removed from the peripheral surface of the photosensitive drum 1a by the cleaner 7a, and then, are recovered by the cleaner 7a.

In this embodiment, the photosensitive drum 1, and the means for processing the photosensitive drum 1, more specifically, the charge roller 2, developing apparatus 4, and cleaner 7, make up a process cartridge 30 which is removably mountable in the main assembly of the image forming apparatus 100.

### 2. Primary Transfer Roller

The primary transfer roller 5 is an elastic roller, which is 10⁵-10⁹ Ω·cm in volume resistivity, and 30° in rubber hardness scale (measured by Asker C hardness meter). It is kept pressed against the photosensitive drum 1 by a total pressure of roughly 9.8 N, with the presence of the intermediary transfer belt 6 between itself and photosensitive drum 1. It is rotated by the rotation of the intermediary transfer belt 6. Further, the image forming apparatus 100 is structured so that −2.0-3.5 kV of voltage can be applied to the primary transfer roller 5 from a primary transfer power source 50 (high voltage power source).

### 3. Intermediary Transfer Belt

The intermediary transfer belt 6 is formed of polyvinylidene fluoride (PVDF), which has been adjusted in volume resistivity by the process of mixing particles of an electrically conductive substance into the polyvinylidene fluoride. Further, the intermediary transfer belt 6 is under a total amount tension of roughly 60 N applied by the tension roller 63 while remaining suspended by the driver roller 61 and tension roller 63.

### 4. Secondary Transfer Roller

The secondary transfer roller 8 is an elastic roller, which is 10⁵-10⁹ Ω·cm in volume resistivity, and 30° in rubber hardness scale (measured by Asker C hardness meter). It is kept pressed against the belt backing roller 62 by a total pressure of roughly 39.2 N, with the presence of the intermediary transfer belt 6 between itself and belt backing roller 62. It is rotated by the rotation of the intermediary transfer belt 6. Further, the image forming apparatus 100 is structured so that −2.0-4.0 kV of voltage can be applied to the secondary transfer roller 8 from a secondary transfer power source (high voltage power source) (unshown).

### 5. Cleaning Brush

The cleaning brush 11 is a brush formed of more or less thickly planted strands of nylon fiber which is 10⁶-10⁹ Ω·cm in electrical conductivity. The cleaning brush 11 in this embodiment is not rotated by the movement of the intermediary transfer belt 6; it is stationary. The reason why a stationary brush is used as the cleaning brush 11 in this embodiment is that a stationary brush is unlikely to scatter the toner, inside the main assembly of the image forming apparatus 100 when it sweeps the intermediary transfer belt 6 to scatter the transfer residual toner particles. In this embodiment, the cleaning brush 11 is disposed so that the amount of theoretical intrusion of the tip of the cleaning brush 11 into the intermediary transfer belt 6 is 1.0 mm. Further, the cleaning brush 11 is kept pressed against the driver roller 61 with the presence of the intermediary transfer belt 6 between the cleaning brush 11 and drive roller 61. The length (dimension in terms of direction perpendicular to moving direction of surface of intermediary transfer belt 6) of the cleaning brush 11 is roughly the same as the width (dimension in terms of direction perpendicular to moving direction of surface of intermediary transfer belt 6) of the intermediary transfer belt 6. Thus, as the intermediary transfer belt 6 is moved, the cleaning brush 11, which is on the upstream side of the cleaning roller 12 in terms of the moving direction of the intermediary transfer belt 6, rubs the outward surface of the intermediary transfer belt 6. Further, the image forming apparatus 100 is structured so that −2.0˜+2.0 kV of DC voltage can be applied to the cleaning brush 11 from the first cleaning power source 13 (high voltage power source), which is the means for supplying the cleaning brush 11 with the cleaning voltage. Because the transfer residual toner are evenly scattered across the intermediary transfer belt 6 by coming into contact with the cleaning brush 11 when the intermediary transfer belt 6 is swept by the cleaning brush 11, it is unnecessary to apply AC voltage to the cleaning brush 11.

### 6. Cleaning Roller

The cleaning roller 12 is an elastic roller, which is 10⁵-10⁹ Ω·cm in volume resistivity. It is kept pressed against the drive roller 61, with the presence of the intermediary transfer belt 6 between itself and drive roller 61. It is rotated by the rotation of the intermediary transfer belt 6. In terms of the direction perpendicular to the moving direction of the outward surface of the intermediary transfer belt 6, the dimension of the cleaning roller 12 is roughly the same as that of the image formable range of the intermediary transfer belt 6. As described above, the cleaning roller 12 is on the downstream side of the cleaning brush 11 in terms of the moving direction of the outward surface of the intermediary transfer belt 6. The peripheral surface of the cleaning roller 12 moves in the same direction as the intermediary transfer belt 6, in the area in which it is in contact with the intermediary transfer belt 6. Further, the image forming apparatus 100 is structured so that −2.0˜+2.0 kV of DC voltage can be applied to the cleaning roller 12 from the second cleaning power source 14 (high voltage power source), which is the means for supplying the cleaning roller 12 with the cleaning voltage.

The reason why a roller is used as the second charging means, which is on the downstream side, is that a roller can more uniformly charge the transfer residual toner particles having been scattered roughly in a single layer. More concretely, the microscopic gaps which a roller forms between itself and the transfer residual toner particles on the intermediary transfer belt 6 are more uniform, across the charging range, than those which a brush forms, and therefore, a roller can more uniformly charge the transfer residual toner particles than a brush.

### 7. Cleaning of Intermediary Transfer Member

Next, the method for cleaning the intermediary transfer belt 6 will be described in detail. The primary object of this embodiment is to prevent the problem that unsatisfactory images are formed because of the unsatisfactory removal of the transfer residual toner particles, by scattering and charging the transfer residual toner particles on the intermediary transfer belt 6 as evenly as possible, in order to clean the intermediary transfer belt 6 at the same time as toner images are transferred from the intermediary transfer belt 6 onto recording medium P.

Thus, in the case of this embodiment, the first and second charging members of the intermediary transfer member cleaning means 10 are structured as follows. That is, in the case of this embodiment, the cleaning brush 11, or the first charging member, is a stationary member positioned to rub the outward surface of the intermediary transfer belt 6. As described above, a stationary cleaning brush is advantageous in that when it scatters the transfer residual toner particles, it does not cause the transfer residual toner particles to fly up into the air as much as a moving (rotational) cleaning brush. Also in the case of this embodiment, the cleaning roller 12, or the second charging member, is a rotational member, which rotates in contact with the intermediary transfer belt 6 in such a direction that the direction in which its peripheral surface moves in the interface between the cleaning roller 12 and intermediary transfer belt 6 is the same direction as the moving direction of the intermediary transfer belt 6 in the interface.

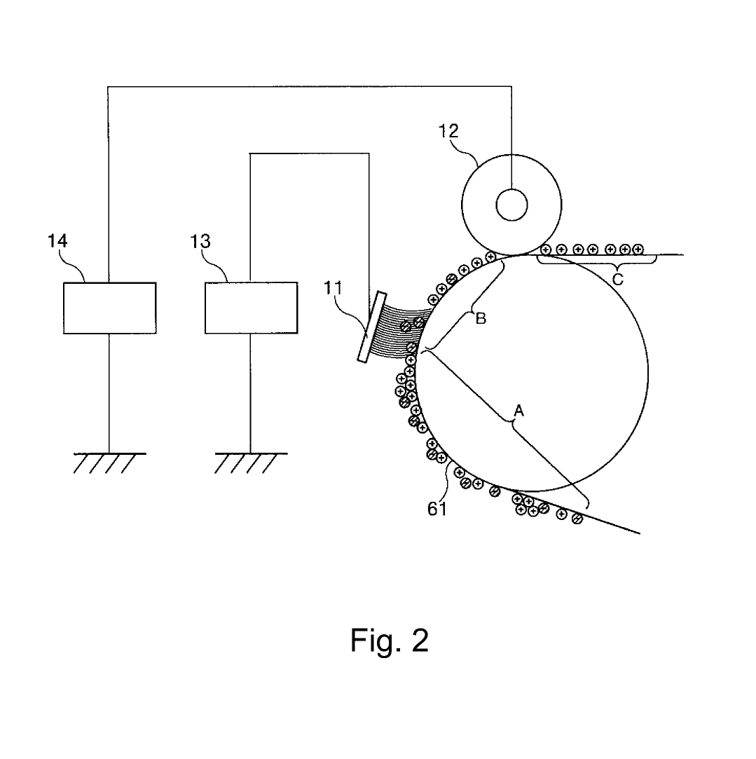

To describe in more detail, FIG. 2 is a schematic enlarged sectional view of the cleaning brush 11, cleaning roller 12, and their adjacencies.

In this embodiment, the toner is negatively charged by the developing apparatus 4, and toner images are transferred by applying positive bias to the primary transfer roller 5 and secondary transfer roller 8 from high voltage power sources. Therefore, the transfer residual toner which remains on the intermediary transfer belt 6 after the secondary transfer process has both the positively charged toner particles and negative charged toner particles, because of the effects of the positive bias applied to the secondary transfer roller 8, as shown in FIG. 2. Also referring to FIG. 2, because of the presence of microscopic unevenness (ridges and valleys) of the surface of the transfer medium P, the transfer residual toner particles remain in layers on some areas of the intermediary transfer belt 6 (area A in FIG. 2).

In this embodiment, therefore, such a bias that is opposite in polarity to the polarity to which toner is normally chargeable, that is, the positive polarity, is applied from the first cleaning power source 13 to the cleaning brush 11, which is on the upstream side of the cleaning roller 12 in terms of the moving direction of the outward surface of the intermediary transfer belt 6. As a result, electrical discharge occurs between the cleaning brush 11 and intermediary transfer belt 6. Thus, when the transfer residual toner particles on the intermediary transfer belt 6 move through the interface between the cleaning brush 11 and intermediary transfer belt 6, they are mostly charged to the positive polarity. Some of the transfer residual toner particles which failed to be positively charged are recovered by the cleaning brush 11.

As for the toner particles having accumulated in layers on the intermediary transfer belt 6, they are scattered in roughly a single layer (area B in FIG. 2) by the pressure from the cleaning brush 11 while they move through the interface between the cleaning brush 11 and intermediary transfer belt 6. That is, the bodies of transfer residual toner on the intermediary transfer belt 6, which are high in density (residual toner particles having remained in layers on intermediary transfer belt 6) can be scattered roughly in a single layer when they pass the interface between the cleaning brush 11 and intermediary transfer belt 6. Then, the evenly scattered residual toner particles are moved by the movement of the intermediary transfer belt 6 in the same direction as the moving direction of the intermediary transfer belt 6.

Next, such a bias that is opposite in polarity to the polarity of the normally charged toner, that is, the positive polarity, is applied from the second cleaning power source 14 to the cleaning roller 12, which is on the downstream side of the cleaning brush 11 in terms of the moving direction of the outward surface of the intermediary transfer belt 6. Thus, while the transfer residual toner particles move through the interface between the cleaning roller 12 and intermediary transfer belt 6, they are given the optimum amount of positive charge for cleaning the intermediary transfer belt 6 at the same time as toner images are transferred onto the intermediary transfer belt 6 (area C in FIG. 2).

That is, the transfer residual toner particles are given the positive charge while being scattered by the cleaning brush 11 so that they become a single layer of residual toner particles. However, while the transfer residual toner particles are given the positive charge by the cleaning brush 11, they have yet to be evenly scattered on the intermediary transfer belt 6. Therefore, even after they have given the positive charge by the cleaning brush 11, they are not equal in the amount of charge. For example, if a given area of the outward surface of the intermediary transfer belt 6, across which the transfer residual toner particles are present, appears darker than another area of the outward surface of the intermediary transfer belt 6, across which the transfer residual toner particles are present, it is possible that the darker area has multiple layers of transfer residual toner particles. Thus, it is possible that the some of the transfer residual toner particles of the dark area might have not be given a sufficient amount of positive charge when they were moved through the electric field generated by the electrical discharge caused between the cleaning brush 11 and intermediary transfer belt 6 by the DC voltage applied to the cleaning brush 11.

Thus, positive charge is given by the cleaning roller 12, which is on the downstream side of the cleaning brush 11, to the transfer residual toner particles having just been evenly scattered across the intermediary transfer belt 6 in terms of the lengthwise direction of the cleaning brush 11. This procedure makes it possible to give virtually the entirety of the transfer residual toner particles on the intermediary transfer belt 6 the optimal amount of positive charge for cleaning the intermediary transfer belt 6 at the same time as toner images are transferred onto the intermediary transfer belt 6.

Thereafter, the transfer residual toner particles having just been given the optimal amount of positive charge are transferred back onto the photosensitive drum 1a (recovered by photosensitive drum 1a) in the primary transfer portion Na of the first station Sa. Incidentally, it is desired that the voltage to be applied to the cleaning brush 11 is set to be smaller in absolute value than the absolute value of the voltage to be applied to the cleaning roller 12, because it is difficult to uniformly charge the transfer residual toner particles on the intermediary transfer belt 6, unless the process for charging them is carried out after they are evenly scattered across the intermediary transfer belt 6.

As described above, in this embodiment, the transfer residual toner particles are charged by the cleaning brush 11, while being evenly scattered across the intermediary transfer belt 6 by the stationary cleaning brush 11 without being caused to fly up into the air. Then, as the outward surface of the intermediary transfer belt 6 moves, the transfer residual toner particles having just been evenly scattered across the surface of the it intermediary transfer belt 6 are given electric charge by the cleaning roller 12, that is, a charging member whose surface moves, in order to ensure that the transfer residual toner particles on the intermediary transfer belt 6 are equally charged. This is why the intermediary transfer belt cleaning method in this embodiment, which cleans the intermediary transfer belt 6 while transferring toner images onto the intermediary transfer belt 6, can more evenly scatter the transfer residual toner particles on the intermediary transfer belt 6, and also, more equally charge them, than any of the comparable intermediary transfer belt cleaning methods in accordance with the prior arts.

In the case of this embodiment, a stationary member which is in the form of a brush is used as the first charging member as described above. However, it should be noted here that the choices of the first charging member are not to be limited to the stationary member in the form of a brush, as long as it can roughly evenly scatter the transfer residual toner particles as effectively as the cleaning brush 11. Also in the case of this embodiment, a rotational member in the form of a roller was used as the second charging member. However, the choices of the second charging member do not need to be limited to a rotational member in the form of a roller, as long as the choice is effective to equally charge the transfer residual toner particles after the particles are roughly evenly scattered. For example, an endless belt or the like is one of the preferable charging member usable as the second charging member.

### Embodiment 2

Next, the image forming apparatus in the second embodiment of the present invention will be described. In terms of the basic structure and operation, this image forming apparatus is the same as the above described image forming apparatus in the first embodiment of the present invention. Thus, the elements of this image forming apparatus, which are the same as, or equivalent in, function and structure as the counterparts in the image forming apparatus in the first preferred embodiment, will be given the same referential codes as those given to the counterparts, and will not be described in detail.

This embodiment of the present invention will be described regarding a method for more effectively charging the transfer residual toner particles on the intermediary transfer belt 6 than that in the first embodiment, more specifically, a method for controlling the voltages to be applied to the cleaning brush 11 (first charging member) and cleaning roller (second charging member), which together make up the intermediary transfer member cleaning means 10.

In this embodiment, the function to give the transfer residual toner particles electric charge is owned by both the cleaning brush 11 and cleaning roller 12.

A desired amount of electric charge can be given to the transfer residual toner particles by controlling the amount of electric discharge by controlling the voltage to be applied to the cleaning brush 11 and the voltage to applied to the cleaning roller 12.

However, the cleaning brush 11 temporarily recovers (primary recovery) the transfer residual toner particles having failed to be charged, at the same time as it gives the transfer residual toner particles electric charge. It is a positive voltage that is applied to the cleaning brush 11. Thus, some of the negatively charged transfer residual toner particles adhere to the cleaning brush 11. Therefore, the repetition of image forming operations causes the transfer residual toner particles to accumulate in the cleaning brush 11. The increase in the amount of toner in the cleaning brush 11 causes the cleaning brush 11 to increase in electrical resistance. In other words, keeping constant the voltage applied to the cleaning brush 11 increases the cleaning brush 11 in electrical resistance, which in turn reduces the cleaning brush 11 in the amount by which electric current flows through the cleaning brush 11. The reduction in the amount by which electric current flows through the cleaning brush 11 reduces the amount by which electricity is discharged from the cleaning brush 11, and the reduction in the amount of electric discharge from the cleaning brush 11 makes it impossible for the cleaning brush 11 to give satisfactory amount of electric charge to the transfer residual toner particles.

In this embodiment, therefore, the voltage to be applied to the cleaning brush 11 is controlled to ensure that the amount by which electric current flows through the cleaning brush 11 remains constant. As long as the amount by which electric current flows through the cleaning brush 11 is kept constant, it is ensured that the amount by which electricity is discharged from the cleaning brush 11 remains constant, and therefore, the cleaning brush 11 remains constant in the amount by which it can give electric charge to the transfer residual toner particles. That is, in this embodiment, the first cleaning power source 13 applies voltage to the cleaning brush 11 in such a manner that the cleaning brush 11 remains constant in the amount by which electric current flows through the cleaning brush 11.

To describe in more detail the method for controlling the image forming apparatus to keep constant the amount by which electric current flows through the cleaning brush 11, a predetermined voltage is applied to the intermediary transfer belt 6 by the cleaning power source 13 while the intermediary transfer belt 6 is circularly driven immediately before the starting of an image forming operation, for example, and the amount by which electric current is flowing through the intermediary transfer belt 6 is detected by the current detection circuit, with which the cleaning power source 13 is provided. Then, the cleaning power source 13 is controlled in the voltage it applies to the intermediary transfer belt 6, in such a manner that the detected amount of electric current remains at a preset level, in order to ensure the cleaning brush 11 remains constant in the amount by which electric current flows through the cleaning brush 11.

On the other hand, the cleaning roller 12 is less likely to be affected by the contamination attributable to toner. Thus, the amount by which electricity is discharged from the cleaning roller 12 can be kept constant by controlling the second cleaning power source 14 in such a manner that the voltage applied to the cleaning roller 12 remains roughly constant. More concretely, the second cleaning power source 14 applies voltage to the cleaning roller 12 in such a manner that the voltage between the cleaning roller 12 and intermediary transfer belt 6 remains constant. The transfer residual toner particles to be charged by the cleaning roller 12 have been already scattered roughly in a single layer by the cleaning brush 11. Thus, for the purpose of making the transfer residual toner particles on the intermediary transfer belt 6 equal in electric charge, it is advantageous to control the second cleaning power source 14 in such a manner that the voltage between the intermediary transfer belt 6 and cleaning roller 12 remains constant.

As described above, in this embodiment, electric charge is given to the transfer residual toner while controlling the voltage to be applied to the cleaning brush 11 (which is on the upstream side of the cleaning roller 12 in terms of the moving direction of the outward surface of the intermediary transfer belt 6) in such a manner that the amount by which electric current flows through the cleaning brush 11 remains constant. On the other hand, the voltage to be applied to the cleaning roller 12 is kept constant. Therefore, even after the image forming apparatus is used a substantial number of times, it can reliably charge the transfer residual toner particles in such a manner that the transfer residual toner particles becomes uniform in electric charge.

### Embodiment 3

Next, the image forming apparatus in another embodiment of the present invention will be described. In terms of the basic structure and operation, this image forming apparatus is the same as the above described image forming apparatuses, that is, the image forming apparatuses in the first and second embodiments of the present invention. Thus, the elements of this image forming apparatus, which are the same as, or equivalent in, function and structure as the counterparts in the image forming apparatuses in the first and second embodiments, will be given the same referential codes as those given to the counterparts, and will not be described in detail. In this embodiment, a more effective method for scattering the transfer residual toner particles on the intermediary transfer belt 6 than the preceding method will be described.

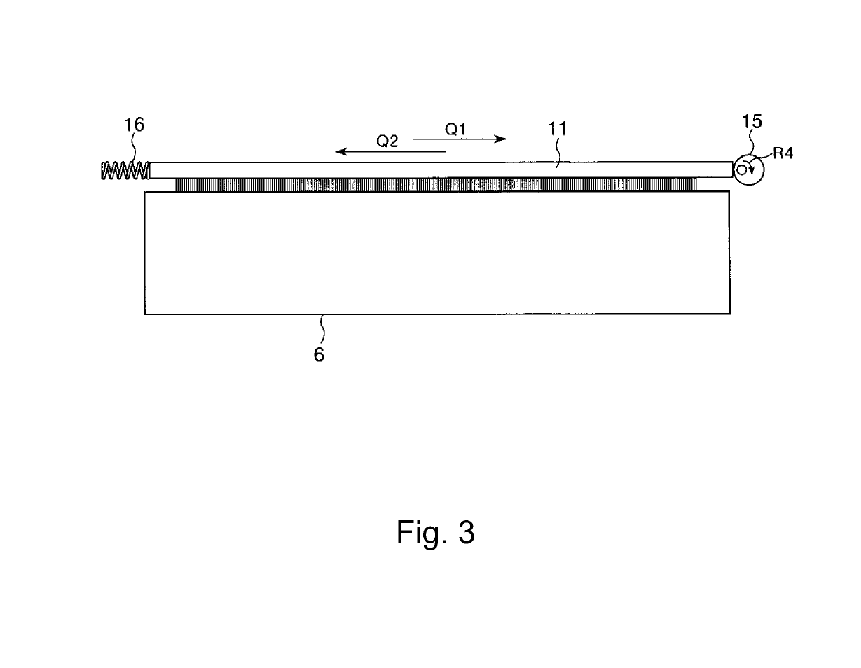

FIG. 3 is a schematic drawing of the cleaning brush 11 and its adjacencies in this embodiment. The cleaning brush 11 in this embodiment is similar to the one in the first embodiment, except that it is movable in the direction perpendicular (roughly perpendicular in this embodiment) to the moving direction of the outward surface of the intermediary transfer belt 6.

To describe in more detail, the image forming apparatus in this embodiment is provided with an eccentric cam 15 as a mechanism for driving the first charging member. The eccentric cam 15 is disposed in contact with one of the lengthwise ends of the cleaning brush 11, and is rotatable in the direction indicated by an arrow mark R4 (clockwise direction) in synchronism with the circular movement of the intermediary transfer belt 6. Further, the image forming apparatus is provided with a spring 16, that is, an elastic member as a means for keeping the cleaning brush 11 under pressure. The spring 16 is disposed at the opposite lengthwise end of the cleaning brush 11 from the eccentric cam 15. The spring 16 keeps the cleaning brush 11 pressed upon the eccentric cam 15 to keep controlled the movement of the cleaning brush 11, which is caused by the rotation of the eccentric cam 15. Thus, the cleaning brush 11 is made to shuttle by the combination of the eccentric cam 15 and spring 16, in the directions indicated by arrow marks Q1 and Q2 in the drawing, in synchronism with the rotation of the intermediary transfer belt 6.

In this embodiment, therefore, it is possible to scatter the transfer residual toner particles on the intermediary transfer belt 6 not only in the direction parallel to the moving direction of the outward surface of the intermediary transfer belt 6, but also, in the direction perpendicular (roughly perpendicular, in this embodiment) to the moving direction of the outward surface of the intermediary transfer belt 6, when the transfer residual toner particles are moved through the interface between the cleaning brush 11 and intermediary transfer belt 6. Therefore, the cleaning brush 11 in this embodiment can more evenly scatter the transfer residual toner particles on the intermediary transfer belt 6 while the transfer residual toner particles are moved through the interface between the cleaning brush 11 and intermediary transfer belt 6, regardless of the various patterns which the transfer residual toner particles form on the intermediary transfer belt 6.

As described above, not only can this embodiment offer the same effects as those provided by the first and second embodiments, but also, more evenly scatter the transfer residual toner particles, regardless of the pattern which the transfer residual toner particles have formed. Therefore, this embodiment can more evenly charge the transfer residual toner particles on the intermediary transfer belt 6 than the preceding embodiments.

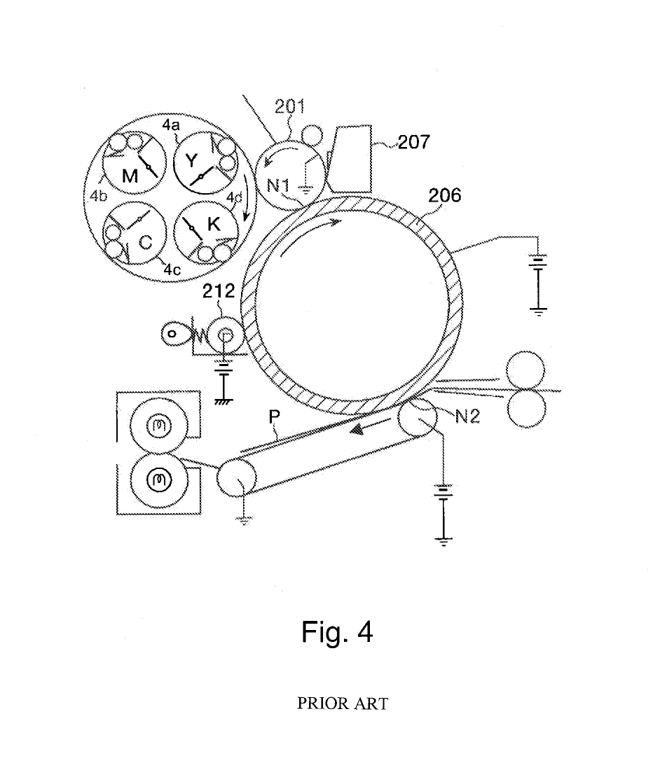

In the above, the present invention was described with reference to the preferred embodiments of the present invention. However, the preferred embodiments are not intended to limit the present invention in scope. For example, in the preceding descriptions of the preferred embodiments, the image forming apparatuses were described as image forming apparatuses of the so-called tandem type. However, the present invention is applicable to an image forming apparatus, such as the one shown in FIG. 4, that is, an image forming apparatus of the so-called single drum type, as effectively as to the image forming apparatuses of the tandem type. To describe more concretely, in the case of an image forming apparatus of the single drum type, multiple monochromatic color toner images are sequentially formed on a single photosensitive member by switching multiple developing apparatuses, and are sequentially transferred (primary transfer) onto the intermediary transfer member while the intermediary transfer member is repeatedly circulated through the primary transfer portion. Thereafter, the multiple monochromatic toner images on the intermediary transfer member are transferred all at once onto the transfer medium. Also in the case of the image forming apparatus of the single drum type, the transfer residual toner particles, that is, the toner particles remaining on the intermediary transfer member after the secondary transfer process, can be recovered by charging them with the use of the intermediary transfer member cleaning means, which is similar to those in the above described preferred embodiments, and then, transferring them back onto the photosensitive member in the primary transfer portion during the next primary transfer process.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Application No. 048839/2008 filed Feb. 28, 2008 which is hereby incorporated by reference.

1. An image forming apparatus, comprising:
an image bearing member for carrying a toner image;
a movable intermediary transfer member for receiving the toner image from said image bearing member;
a primary transfer member for being supplied with a voltage and for primary transfer of the toner image from said image bearing member onto said intermediary transfer member in a primary transfer station;
a secondary transfer member for being supplied with a voltage and for secondary transfer of the toner image from said intermediary transfer member onto a transfer material in a secondary transfer station;
a first charging member for electrically charging toner remaining in a region upstream of the primary transfer station and downstream of the secondary transfer station;
a first voltage source for applying a voltage to said first charging member; and
a second charging member for electrically charging the toner remaining in a region upstream of the primary transfer station and downstream of said first charging member;
a second voltage source for applying a voltage to said second charging member,
wherein said first charging member rubs a surface of said intermediary transfer member with movement of said intermediary transfer member, and said second charging member moves in contact with said intermediary transfer member in the same direction as said intermediary transfer member in a contact region therebetween, thereby to transfer the toner remaining on said intermediary transfer member after the secondary transfer, back to said image bearing member from said intermediary transfer member simultaneously with the primary transfer at the primary transfer station.

2.-9. (canceled)
